(19) United States
(12) Patent Application Publication
(10) Pub. No.: US 2022/0066157 A1
(43) Pub. Date: Mar. 3, 2022

(54) CAMERA OPTICAL LENS

(71) Applicant: AAC Optics (Suzhou) Co., Ltd., Suzhou City (CN)

(72) Inventors: Chiacheng Lin, Shenzhen (CN); Wen Sun, Shenzhen (CN)

(21) Appl. No.: 17/134,172

(22) Filed: Dec. 25, 2020

(30) Foreign Application Priority Data
Sep. 2, 2020 (CN) 202010912062.5

(51) Int. Cl. G02B 13/00; G02B 9/64; G02B 13/06; G02B 13/04

(52) U.S. Cl. CPC G02B 13/0045; G02B 13/04; G02B 13/06; G02B 9/64

(57) ABSTRACT

A camera optical lens is provided, including from an object side to an image side: a first lens having positive refractive power; a second lens having negative refractive power; a third lens having positive refractive power; a fourth lens having positive refractive power; a fifth lens having negative refractive power; a sixth lens having positive refractive power; and a seventh lens having negative refractive power. The camera optical lens satisfies following conditions: −4.00≤f2/f≤−1.50; 3.20≤f5/f7≤7.50; R7/R8<−3.20, f denotes total focal length of the camera optical lens; f2 denotes focal length of second lens; f5 denotes focal length of fifth lens; f7 denotes focal length of seventh lens; R7 denotes curvature radius of object side surface of fourth lens; R8 denotes curvature radius of image side surface of fourth lens. The above camera optical lens may meet design requirements for large aperture, wide angle and ultra-thinness, while maintaining good imaging quality.

### TECHNICAL FIELD

The present invention relates to the technical field of optical lens and, in particular, to a camera optical lens suitable for handheld terminal devices such as smart phones or digital cameras, and imaging devices such as monitors or PC lenses.

### BACKGROUND

With the emergence of smart phones in recent years, the demand for a miniature camera lens is continuously increasing, but in general, photosensitive devices of a camera lens are nothing more than a Charge Coupled Device (CCD) or a Complementary Metal-Oxide Semiconductor Sensor (CMOS sensor), and as progress of semiconductor manufacturing technology makes a pixel size of the photosensitive devices become smaller, in addition, a current development trend of electronic products requires better performance with thinner and smaller dimensions, miniature camera lenses with good imaging quality therefore have become a mainstream in the market.

In order to obtain better imaging quality, a camera lens traditionally equipped in a camera of a mobile phone generally constitutes three, four, even five or six lenses. However, with development of technology and increase in diversified requirements of users, a camera lens constituted by seven lenses gradually appears in camera design, in case that a pixel area of the photosensitive device is continuously reduced and requirements on imaging quality is continuously increased. Although the common camera lens constituted by seven lenses has good optical performances, its configuration such as refractive power, lens spacing and lens shape still need to be optimized, therefore the camera lens may not meet design requirements for some optical performances such as large aperture, wide angle and ultra-thinness while maintaining good imaging quality.

### SUMMARY

In view of the above problems, the present invention provides a camera optical lens, which may meet design requirements on some optical performances such as large aperture, wide angle and ultra-thinness while maintaining good imaging quality.

Embodiments of the present invention provide a camera optical lens, including from an object side to an image side:
a first lens having positive refractive power;
a second lens having negative refractive power;
a third lens having positive refractive power;
a fourth lens having positive refractive power;
a fifth lens having negative refractive power;
a sixth lens having positive refractive power; and
a seventh lens having negative refractive power,
wherein the camera optical lens satisfies following conditions:
−4.00≤f2/f≤−1.50;
3.20≤f5/f7≤7.50; and
R7/R8≤−3.20,
where
f denotes a total focal length of the camera optical lens;
f2 denotes a focal length of the second lens;
f5 denotes a focal length of the fifth lens;
f7 denotes a focal length of the seventh lens;
R7 denotes a curvature radius of an object side surface of the fourth lens; and
R8 denotes a curvature radius of an image side surface of the fourth lens.

As an improvement, the camera optical lens satisfies a following condition:
2.00≤d1/d3≤4.00,
where
d1 denotes an on-axis thickness of the first lens; and
d3 denotes an on-axis thickness of the second lens.

As an improvement, the camera optical lens satisfies following conditions:
0.43≤f1/f≤1.64;
−9.16≤(R1+R2)/(R1−R2)≤≤1.29; and
0.06≤d1/TTL≤0.19,
where
f1 denotes a focal length of the first lens;
R1 denotes a central curvature radius of an object side surface of the first lens;
R2 denotes a central curvature radius of an image side surface of the first lens;
d1 denotes an on-axis thickness of the first lens; and
TTL denotes a total optical length from the object side surface of the first lens to an image plane of the camera optical lens along an optic axis.

As an improvement, the camera optical lens satisfies following conditions:
−219.71≤(R3+R4)/(R3−R4)≤−4.52; and
0.02≤d3/TTL≤0.09,
where
R3 denotes a curvature radius of an object side surface of the second lens;
R4 denotes a curvature radius of an image side surface of the second lens;
d3 denotes an on-axis thickness of the second lens; and
TTL denotes a total optical length from an object side surface of the first lens to an image plane of the camera optical lens along an optic axis.

As an improvement, the camera optical lens satisfies following conditions:
2.19≤f3/f≤192.13;
0.21≤(R5+R6)/(R5−R6)≤0.83; and
0.02≤d5/TTL≤0.06,
where
f3 denotes a focal length of the third lens;
R5 denotes a curvature radius of an object side surface of the third lens;
R6 denotes a curvature radius of an image side surface of the third lens;
d5 denotes an on-axis thickness of the third lens; and
TTL denotes a total optical length from an object side surface of the first lens to an image plane of the camera optical lens along an optic axis.

As an improvement, the camera optical lens satisfies following conditions:
1.44≤f4/f≤11.18;
0.27≤(R7+R8)/(R7−R8)≤1.37; and
0.04≤d7/TTL≤0.12,
where
f4 denotes a focal length of the fourth lens;
R7 denotes a curvature radius of an object side surface of the fourth lens;
R8 denotes a curvature radius of an image side surface of the fourth lens;
d7 denotes an on-axis thickness of the fourth lens; and
TTL denotes a total optical length from an object side surface of the first lens to an image plane of the camera optical lens along an optic axis.

As an improvement, the camera optical lens satisfies following conditions:
−9.07≤f5/f≤−1.53;
0.28≤(R9+R10)/(R9−R10)≤1.08; and
0.02≤d9/TTL≤0.08,
R9 denotes a curvature radius of an object side surface of the fifth lens;
R10 denotes a curvature radius of an image side surface of the fifth lens;
d9 denotes an on-axis thickness of the fifth lens; and
TTL denotes a total optical length from an object side surface of the first lens to an image plane of the camera optical lens along an optic axis.

As an improvement, the camera optical lens satisfies following conditions:
0.48≤f6/f≤1.53;
1.53≤(R11+R12)/(R11−R12)≤4.76; and
0.05≤d11/TTL≤0.21,
where
f6 denotes a focal length of the sixth lens;
R11 denotes a curvature radius of an object side surface of the sixth lens;
R12 denotes a curvature radius of an image side surface of the sixth lens;
d11 denotes an on-axis thickness of the sixth lens; and
TTL denotes a total optical length from an object side surface of the first lens to an image plane of the camera optical lens along an optic axis.

As an improvement, the camera optical lens satisfies following conditions:
−1.41≤f7/f≤−0.41;
0.20≤(R13+R14)/(R13−R14)≤0.75; and
0.03≤d13/TTL≤0.11,
F7 denotes a focal length of the seventh lens;
R13 denotes a curvature radius of an object side surface of the seventh lens;
R14 denotes a curvature radius of an image side surface of the seventh lens;
d13 denotes an on-axis thickness of the seventh lens; and
TTL denotes a total optical length from an object side surface of the first lens to an image plane of the camera optical lens along an optic axis.

As an improvement, the camera optical lens satisfies a following condition:
FNO≤1.82,
where FNO denotes an F number of the camera optical lens.

The present invention has following beneficial effects: the camera optical lens according to the present invention not only has excellent optical performances, but also has large aperture, wide angle, and ultra-thinness properties, which is especially suitable for mobile phone camera lens components composed of high-pixel CCD, CMOS and other imaging elements and WEB camera lens.

### BRIEF DESCRIPTION OF DRAWINGS

Many aspects of the exemplary embodiments may be better understood with reference to following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a structural schematic diagram of a camera optical lens according to Embodiment 1 of the present invention;

FIG. 2 is a schematic diagram of a longitudinal aberration of the camera optical lens shown in FIG. 1;

FIG. 3 is a schematic diagram of a lateral color of the camera optical lens shown in FIG. 1;

FIG. 4 is a schematic diagram of a field curvature and a distortion of the camera optical lens shown in FIG. 1;

FIG. 5 is a structural schematic diagram of a camera optical lens according to Embodiment 2 of the present invention;

FIG. 6 is a schematic diagram of a longitudinal aberration of the camera optical lens shown in FIG. 5;

FIG. 7 is a schematic diagram of a lateral color of the camera optical lens shown in FIG. 5;

FIG. 8 is a schematic diagram of a field curvature and a distortion of the camera optical lens shown in FIG. 5;

FIG. 9 is a structural schematic diagram of a camera optical lens according to Embodiment 3 of the present invention;

FIG. 10 is a schematic diagram of a longitudinal aberration of the camera optical lens shown in FIG. 9;

FIG. 11 is a schematic diagram of a lateral color of the camera optical lens shown in FIG. 9; and

FIG. 12 is a schematic diagram of a field curvature and a distortion of the camera optical lens shown in FIG. 9.

### DESCRIPTION OF EMBODIMENTS

In order to better illustrate the objectives, technical solutions and advantages of the present invention, the present invention will be described in further detail below with reference to the accompanying drawings and embodiments. It should be understood that the specific embodiments described herein are only used to explain the present invention but are not used to limit the present invention.

### Embodiment 1

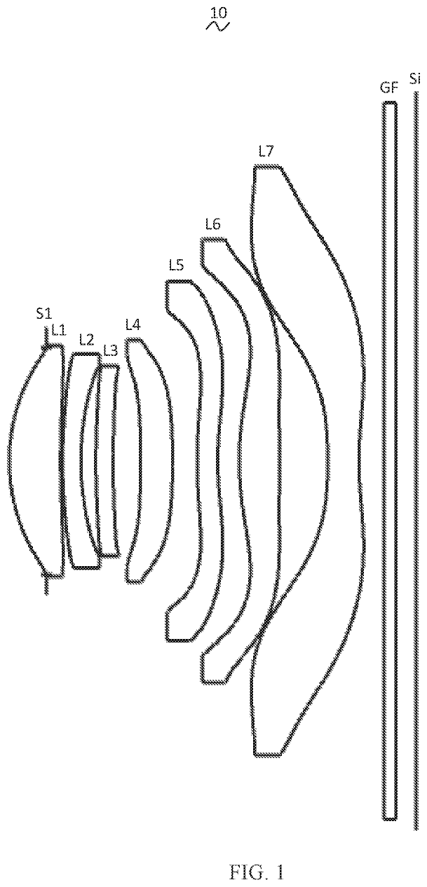

Referring to FIG. 1, the present invention provides a camera optical lens 10. FIG. 1 shows a camera optical lens 10 according to Embodiment 1 of the present invention. The camera optical lens 10 includes seven lenses. The camera optical lens 10 includes, from an object side to an image side: an aperture S1, a first lens L1, a second lens L2, a third lens L3, a fourth lens L4, a fifth lens L5, a sixth lens L6 and a seventh lens L7. A glass plate GF is arranged between the seventh lens L7 and an image plane Si. The glass plate GF may be a cover glass or an optical filter.

In this embodiment, the first lens L1 has positive refractive power, the second lens L2 has negative refractive power, the third lens L3 has positive refractive power, the fourth lens L4 has positive refractive power, the fifth lens L5 has negative refractive power, the sixth lens L6 has positive refractive power and the seventh lens L7 has negative refractive power.

In this embodiment, the first lens L1, the second lens L2, the third lens L3, the fourth lens L4, the fifth lens L5, the sixth lens L6 and the seventh lens L7 are each made of a plastic material.

Here, a total focal length of the camera optical lens 10 is defined as f, a focal length of the second lens L2 is defined as f2, a focal length of the fifth lens L5 is defined as f5, a focal length of the seventh lens L7 is defined as f7, and a curvature radius of an object side surface of the fourth lens L4 is defined as R7, a curvature radius of an image side surface of the fourth lens L4 is defined as R8. The focal length f2 and the focal length f, the focal length f5 and the focal length f7, the curvature radius R7 and the curvature radius R8 satisfy following conditions:

−4.00≤f2/f≤−1.50 (1);

3.20≤f5/f7≤7.50 (2); and

R7/R8≤−3.20 (3).

Here, the condition (1) specifies a ratio of the focal length f2 of the second lens L2 to the total focal length f of the camera optical lens 10. Within the range of the condition (1), aberration of the optical system may be corrected, thereby improving the imaging quality.

The condition (2) specifies a ratio of the focal length f5 of the fifth lens L5 to the focal length f7 of the seventh lens L7. With appropriate configuration of the focal length of the fifth lens and the seventh lens, imaging quality may be improved within the range of the condition (2).

The condition (3) specifies a shape of the fourth lens L4. Within the range specified by the condition (3), a degree of deflection of light passing through the lens may be alleviated, and aberrations may be effectively reduced.

An on-axis thickness of the first lens L1 is defined as d1, and an on-axis thickness of the second lens L2 is defined as d3. The on-axis thickness d1 and the on-axis thickness d3 satisfy a following condition: 2.00≤d1/d3≤4.00. With appropriate configuration of the thickness of the first lens and the second lens, it is beneficial to processing and assembling the lenses within the range of the above condition.

In this embodiment, the object side surface of the first lens L1 is convex in a paraxial region, and the image side surface of the first lens L1 is concave in the paraxial region.

The total focal length of the camera optical lens 10 is defined as f, a focal length of the first lens L1 is defined as f1. The focal length f1 and the focal length f satisfy a following condition: 0.43≤f1/f≤1.64, which specifies a ratio of the focal length f1 if the first lens to the focal length f of the camera optical lens. Within the range of the above condition, the first lens has appropriate positive refractive power, so that it is beneficial to reduce aberrations of the system while it is beneficial to development of ultra-thinness and wide-angle of the camera optical lens. Optionally, the focal length f1 and the focal length f satisfy a following condition: 0.69≤f1/f≤1.31.

A central curvature radius of an object side surface of the first lens L1 is defined as R1, and a central curvature radius of an image side surface of the first lens L1 is defined as R2. The central curvature radius R1 and the central curvature radius R2 satisfy a following condition: −9.16≤(R1+R2)/(R1−R2)≤−1.29. A shape of the first lens L1 is reasonably controlled, so that the first lens L1 may effectively correct spherical aberration of the system. Optionally, the central curvature radius R1 and the central curvature radius R2 satisfy a following condition: −5.73≤(R1+R2)/(R1−R2)≤−1.61.

An on-axis thickness of the first lens L1 is defined as d1, and a total optical length from the object side surface of the first lens to an image plane of the camera optical lens 10 along an optic axis is defined as TTL. The on-axis thickness d1 and the total optical length TTL satisfy a following condition: 0.06≤d1/TTL≤0.19. Within the range of the above condition, it is beneficial to achieve an ultra-thinness effect. Optionally, the on-axis thickness d1 and the total optical length TTL satisfy a following condition: 0.10≤d1/TTL≤0.15.

In this embodiment, the object side surface of the second lens L2 is convex in a paraxial region, and the image side surface of the second lens L2 is concave in the paraxial region.

A central curvature radius of an object side surface of the second lens L2 is defined as R3, and a central curvature radius of an image side surface of the second lens L2 is defined as R4. The central curvature radius R3 and the central curvature radius R4 satisfy a following condition: −219.71≤(R3+R4)/(R3−R4)≤−4.52, which specifies a shape of the second lens L2. Within the range of the above condition, as the camera optical lens becomes ultra-thinness and wide-angle, it is beneficial to correct on-axis chromatic aberration. Optionally, the central curvature radius R3 and the central curvature radius R4 satisfy a following condition: −137.32≤(R3+R4)/(R3−R4)≤−5.66.

The total optical length from the object side surface of the first lens to an image plane of the camera optical lens 10 is defined as TTL, and an on-axis thickness of the second lens L2 is defined as d3. The on-axis thickness d3 and the total optical length TTL satisfy a following condition: 0.02≤d3/TTL≤0.09. Within the range of the above condition, it is beneficial to achieve an ultra-thinness effect. Optionally, the on-axis thickness d3 and the total optical length TTL satisfy a following condition: 0.03≤d3/TTL≤0.07.

In this embodiment, the object side surface of the third lens L3 is convex in a paraxial region, and the image side surface of the third lens L3 is convex in the paraxial region.

The total focal length of the camera optical lens 10 is defined as f, and a focal length of the third lens L3 is defined as f3. The focal length f3 and the focal length f satisfy a following condition: 2.19≤f3/f≤192.13. With appropriate configuration of the positive refractive power of the third lens L3, the system may obtain better imaging quality and lower sensitivity. Optionally, the focal length f3 and the focal length f satisfy a following condition: 3.50≤f3/f≤153.70.

A central curvature radius of an object side surface of the third lens L3 is defined as R5, and a central curvature radius of an image side surface of the third lens L3 is R6. The central curvature radius R5 and the central curvature radius R6 satisfy following condition: 0.21≤(R5+R6)/(R5−R6)≤0.83, which specifies a shape of the third lens L3. Within the specified range of the condition, a degree of deflection of light passing through the lens may be alleviated, and aberrations may be effectively reduced. Optionally, the central curvature radius R5 and the central curvature radius R6 satisfy a following condition: 0.33≤(R5+R6)/(R5−R6)≤0.66.

The total optical length from the object side surface of the first lens to an image plane of the camera optical lens 10 is defined as TTL, and an on-axis thickness of the third lens L3 is defined as d5. The on-axis thickness d5 and the total optical length TTL satisfy a following condition: 0.02≤d5/TTL≤0.06. Within the range of the above condition, it is beneficial to achieve an ultra-thinness effect. Optionally, the on-axis thickness d5 and the total optical length TTL satisfy a following condition: 0.03≤d5/TTL≤0.05.

In this embodiment, the object side surface of the fourth lens L4 is concave in a paraxial region, and the image side surface of the fourth lens L4 is concave in the paraxial region.

The total focal length of the camera optical lens 10 is f, and the focal length of the fourth lens L4 is defined as f4. The focal length f4 and the focal length f satisfy a following condition: 1.44≤f4/f≤11.18, which specifies a ratio of the focal length of the fourth lens to the focal length of the camera optical lens. With appropriate configuration of the positive refractive power of the fourth lens L4, the system may obtain better imaging quality and lower sensitivity. Optionally, the focal length f4 and the focal length f satisfy a following condition: 2.30≤f4/f≤8.94.

A central curvature radius of an object side surface of the fourth lens L4 is defined as R7, and a central curvature radius of an image side surface of the fourth lens L4 is defined as R8. The central curvature radius R7 and the central curvature radius R8 satisfy a following condition: 0.27≤(R7+R8)/(R7−R8)≤1.37, which specifies a shape of the fourth lens L4. Within the range of the above condition, it is beneficial to correct the aberration of off-axis angle with the development of ultra-thinness and wide-angle. Optionally, the central curvature radius R7 and the central curvature radius R8 satisfy a following condition: 0.43≤(R7+R8)/(R7−R8)≤1.09.

The total optical length from the object side surface of the first lens to an image plane of the camera optical lens 10 is defined as TTL, and an on-axis thickness of the fourth lens L4 is defined as d7. The on-axis thickness d7 and the total optical length TTL satisfy a following condition: 0.04≤d7/TTL≤0.12. Within the range of the above condition, it is beneficial to achieve an ultra-thinness effect. Optionally, the on-axis thickness d7 and the total optical length TTL satisfy a following condition: 0.06≤d7/TTL≤0.10.

In this embodiment, the object side surface of the fifth lens L5 is convex in a paraxial region, and the image side surface of the fifth lens L5 is convex in the paraxial region.

The total focal length of the camera optical lens 10 is defined as f, and a focal length of the fifth lens L5 is defined as f5. The focal length f5 and the focal length f satisfy a following condition: −9.07≤f5/f≤−1.53. The limitation on the fifth lens L5 may effectively make the camera optical lens have a gentle light angle, thereby reducing tolerance sensitivity. Optionally, the focal length f5 and the focal length f satisfy a following condition: it satisfies −5.67≤f5/f≤−1.91.

A central curvature radius of an object side surface of the fifth lens L5 is defined as R9, and a central curvature radius of an image side surface of the fifth lens L5 is defined as R10. The central curvature radius R9 and the central curvature radius R10 satisfy a following condition: 0.28≤(R9+R10)/(R9−R10)≤1.08, which specifies a shape of the fifth lens. Within the range of the above condition, it is beneficial to correct the aberration of off-axis angle with the development of ultra-thinness and wide-angle. Optionally, the central curvature radius R9 and the central curvature radius R10 satisfy a following condition: 0.45≤(R9+R10)/(R9−R10)≤0.87.

The total optical length from the object side surface of the first lens to an image plane of the camera optical lens 10 is defined as TTL, and an on-axis thickness of the fifth lens L5 is defined as d9. The on-axis thickness d9 and the total optical length TTL satisfy a following condition: 0.02≤d9/TTL≤0.08. Within the range of the above condition, it is beneficial to achieve an ultra-thinness effect. Optionally, the on-axis thickness d9 and the total optical length TTL satisfy a following condition: 0.03≤d9/TTL≤0.06.

In this embodiment, the object side surface of the sixth lens L6 is convex in a paraxial region, and the image side surface of the sixth lens L6 is concave in the paraxial region.

The total focal length of the camera optical lens 10 is defined as f, and a focal length of the sixth lens L6 is defined as f6. The focal length f6 and the focal length f satisfy a following condition: 0.48≤f6/f≤1.53. With appropriate configuration of the positive refractive power of the sixth lens L6, the system may obtain better imaging quality and lower sensitivity. Optionally, the focal length f6 and the focal length f satisfy a following condition: 0.76≤f6/f≤1.23.

A curvature radius of an object side surface of the sixth lens L6 is defined as R11, and a curvature radius of an image side surface of the sixth lens L6 is defined as R12. The curvature radius R11 and the curvature radius R12 satisfy a following condition: 1.53≤(R11+R12)/(R11−R12)≤4.76, which specifies a shape of the sixth lens L6. Within the range of the above condition, it is beneficial to correct aberration of off-axis angle with the development of ultra-thinness and wide angle. Optionally, the curvature radius R11 and the curvature radius R12 satisfy a following condition: 2.45≤(R11+R12)/(R11−R12)≤3.80.

The total optical length from the object side surface of the first lens to an image plane of the camera optical lens 10 is defined as TTL, and an on-axis thickness of the sixth lens L6 is defined as d11. The on-axis thickness d11 and the total optical length TTL satisfy a following condition: 0.05≤d11/TTL≤0.21, which is beneficial to achieve an ultra-thinness effect. Optionally, the on-axis thickness d11 and the total optical length TTL satisfy a following condition: 0.08≤d11/TTL≤0.16.

In this embodiment, the object side surface of the seventh lens L7 is concave in a paraxial region, and the image side surface of the seventh lens L7 is concave in the paraxial region.

The total focal length of the camera optical lens 10 is defined as f, and a focal length of the seventh lens L7 is defined as f7. The focal length f7 and the focal length f satisfy a following condition: −1.41≤f7/f≤−0.41. With appropriate configuration of the negative refractive power of the seventh lens L7, the system may obtain better imaging quality and lower sensitivity. Optionally, the focal length f7 and the focal length f satisfy a following condition: −0.88≤f7/f≤−0.52.

A curvature radius of an object side surface of the seventh lens L7 is defined as R13, and a curvature radius of an image side surface of the seventh lens L7 is defined as R14. The curvature radius R13 and the curvature radius R14 satisfy a following condition: 0.20≤(R13+R14)/(R13−R14)≤0.75, which specifies a shape of the seventh lens L7. Within the range of the above condition, it is beneficial to correct aberration of off-axis angle with the development of ultra-thinness and wide angle. Optionally, the curvature radius R13 and the curvature radius R14 satisfy a following condition: 0.32≤(R13+R14)/(R13−R14)≤0.60.

The total optical length from the object side surface of the first lens to an image plane of the camera optical lens 10 is defined as TTL, and an on-axis thickness of the seventh lens L7 is defined as d13. The on-axis thickness d13 and the total optical length TTL satisfy a following condition: 0.03≤d13/TTL≤0.11. Within the range of the above condition, it is beneficial to achieve an ultra-thinness effect. Optionally, the on-axis thickness d13 and the total optical length TTL satisfy a following condition: 0.06≤d13/TTL≤0.09.

In this embodiment, an image height of the camera optical lens 10 is defined as IH, and the total optical length from the object side surface of the first lens to an image plane of the camera optical lens 10 is defined as TTL. The image height IH and the total optical length TTL satisfy a following condition: TTL/IH≤1.35. Within the range of the above condition, it is beneficial to achieve an ultra-thinness effect.

In this embodiment, an F number FNO of the camera optical lens 10 satisfies a following condition: FNO≤1.82, so that a large aperture is achieved.

In this embodiment, a field of view FOV of the camera optical lens 10 is greater than or equal to 82.00°, so that a wide angle is achieved.

In this embodiment, the total focal length of the camera optical lens 10 is f, and the combined focal length of the first lens L1 and the second lens L2 is defined as f12. The focal length f and the combined focal length f12 satisfy a following condition: 0.68≤f12/f≤2.43. Within the range of the above condition, the aberration and distortion of the camera optical lens 10 may be eliminated, and a back focal length of the camera optical lens 10 may be suppressed, so that miniaturization of an imaging lens system may be maintained. Optionally, the combined focal length f12 and the focal length f satisfy a following condition: 1.09≤f12/f≤1.94.

In addition, in the camera optical lens 10 provided by this embodiment, the surface of each lens may be configured to be an aspherical surface. The aspherical surface may be easily made into a shape other than a spherical surface, so that more control variables may be obtained to reduce aberrations, thereby reducing the number of lens used. Therefore, a total length of the camera optical lens 10 may be effectively reduced. In this embodiment, each of the object side surface and the image side surface of each lens is an aspherical surface.

When the focal length of the camera optical lens 10, the focal length and the curvature radius of each lens according to the present invention satisfy the above-mentioned conditions, the camera optical lens 10 may meet the design requirements on large aperture, wide angle and ultra-thinness while maintaining good optical performances. According to performances of the camera optical lens 10, the camera optical lens 10 is especially suitable for mobile phone camera lens components composed of high-pixel CCD, CMOS and other imaging elements and WEB camera lens.

The camera optical lens 10 of the present invention will be described below with examples. The symbols recorded in each example will be described as follows. The focal length, on-axis distance, curvature radius, on-axis thickness, inflection point position, and arrest point position are all in units of millimeter (mm). The symbols described in each example are as follows. The focal length, on-axis distance, curvature radius, on-axis thickness, inflection point position, and arrest point position are each in unit of millimeter (mm).

TTL denotes a total optical length from the object side surface of the first lens to an image plane Si of the camera optical lens 10, with a unit of millimeter (mm);

F number FNO denotes a ratio of an effective focal length of the camera optical lens to an entrance pupil diameter ENPD.

In addition, the object side surface and/or image side surface of each lens may also be provided with inflection points and/or arrest points in order to meet high-quality imaging requirements. The description below may be referred to in specific embodiments as follows.

The design data of the camera optical lens 10 in FIG. 1 are shown below.

Table 1 shows the curvature radius R of the object side surface and the image side surface of the first lens L1 to the sevens lens L7 which constitute the camera optical lens 10 according to Embodiment 1 of the present invention, the on-axis thickness of each lens, and the distance d between two adjacent lenses, refractive indexes nd and Abbe numbers vd. It should be noted that R and d are both are each in unit of millimeter (mm) in this embodiment.

TABLE 1

| | R | d | | nd | | vd | |
|---|---|---|---|---|---|---|---|
| S1 | ∞ | d0 = | −0.636 | | | | |
| R1 | 3.175 | d1 = | 0.879 | nd1 | 1.5444 | v1 | 55.82 |
| R2 | 6.589 | d2 = | 0.037 | | | | |
| R3 | 3.607 | d3 = | 0.312 | nd2 | 1.6700 | v2 | 19.39 |
| R4 | 4.183 | d4 = | 0.258 | | | | |
| R5 | 16.699 | d5 = | 0.300 | nd3 | 1.6153 | v3 | 25.94 |
| R6 | −4.817 | d6 = | 0.472 | | | | |
| R7 | −9.070 | d7 = | 0.548 | nd4 | 1.5444 | v4 | 55.82 |
| R8 | 1.199 | d8 = | 0.423 | | | | |
| R9 | 6.525 | d9 = | 0.353 | nd5 | 1.5876 | v5 | 29.04 |
| R10 | −1.054 | d10 = | 0.369 | | | | |
| R11 | 3.362 | d11 = | 0.691 | nd6 | 1.5346 | v6 | 55.69 |
| R12 | 1.744 | d12 = | 0.832 | | | | |
| R13 | −6.063 | d13 = | 0.533 | nd7 | 1.5444 | v7 | 55.82 |
| R14 | 2.563 | d14 = | 0.436 | | | | |
| R15 | ∞ | d15 = | 0.210 | ndg | 1.5168 | vg | 64.17 |
| R16 | ∞ | d16 = | 0.343 | | | | |

The reference signs are explained as follows.

S1: aperture;

R: curvature radius of an optical surface;

R1: curvature radius of the object side surface of the first lens L1;

R2: curvature radius of the image side surface of the first lens L1;

R3: curvature radius of the object side surface of the second lens L2;

R4: curvature radius of the image side surface of the second lens L2;

R5: curvature radius of the object side surface of the third lens L3;

R6: curvature radius of the image side surface of the third lens L3;

R7: curvature radius of the object side surface of the fourth lens L4;

R8: curvature radius of the image side surface of the fourth lens L4;

R9: curvature radius of the object side surface of the fifth lens L5;

R10: curvature radius of the image side surface of the fifth lens L5;

R11: curvature radius of the object side surface of the sixth lens L6;

R12: curvature radius of the image side surface of the sixth lens L6;

R13: curvature radius of the object side surface of the seventh lens L7;

R14: curvature radius of the image side surface of the seventh lens L7;

R15: curvature radius of an object side surface of the optical filter GF;

R16: curvature radius of an image side surface of the optical filter GF;

d: on-axis thickness of a lens and an on-axis distance between lenses;

d0: on-axis distance from the aperture S1 to the object side surface of the first lens L1;

d1: on-axis thickness of the first lens L1;

d2: on-axis distance from the image side surface of the first lens L1 to the object side surface of the second lens L2;

d3: on-axis thickness of the second lens L2;

d4: on-axis distance from the image side surface of the second lens L2 to the object side surface of the third lens L3;

d5: on-axis thickness of the third lens L3;

d6: on-axis distance from the image side surface of the third lens L3 to the object side surface of the fourth lens L4;

d7: on-axis thickness of the fourth lens L4;

d8: on-axis distance from the image side surface of the fourth lens L4 to the object side surface of the fifth lens L5;

d9: on-axis thickness of the fifth lens L5;

d10: on-axis distance from the image side surface of the fifth lens L5 to the object side surface of the sixth lens L6;

d11: on-axis thickness of the sixth lens L6;

d12: on-axis distance from the image side surface of the sixth lens L6 to the object side surface of the optical filter GF;

d13: on-axis thickness of the seventh lens L7;

d14: on-axis distance from the image side surface of the seventh lens L7 to the object side surface of the optical filter GF;

d15: on-axis thickness of the optical filter GF;

d16: on-axis distance from the image side surface of the optical filter GF to the image plane Si;

nd: refractive index of a d-line;

nd1: refractive index of the d-line of the first lens L1;

nd2: refractive index of the d-line of the second lens L2;

nd3: refractive index of the d-line of the third lens L3;

nd4: refractive index of the d-line of the fourth lens L4;

nd5: refractive index of the d-line of the fifth lens L5;

nd6: refractive index of the d-line of the sixth lens L6;

nd7: refractive index of the d-line of the seventh lens L7;

ndg: refractive index of the d-line of the optical filter GF;

vd: Abbe number;

v1: Abbe number of the first lens L1;

v2: Abbe number of the second lens L2;

v3: Abbe number of the third lens L3;

v4: Abbe number of the fourth lens L4;

v5: Abbe number of the fifth lens L5;

v6: Abbe number of the sixth lens L6;

v7: Abbe number of the seventh lens L7;

vg: Abbe number of the optical filter GF.

Table 2 shows aspherical surface data of each lens in the camera optical lens 10 according to Embodiment 1 of the present invention.

TABLE 2

| | Conic | | | | | |
|---|---|---|---|---|---|---|
| | coefficient | Aspherical surface coefficient | | | | |
| | k | A4 | A6 | A8 | A10 | Al2 |
| R1 | −2.7433E−01 | 5.2106E−03 | 4.4897E−03 | −5.9016E−03 | 4.9289E−03 | −2.6192E−03 |
| R2 | −7.1437E+01 | −2.9435E−03 | 1.8636E−02 | −2.7329E−02 | 2.7063E−02 | −1.8143E−02 |
| R3 | −1.4587E+01 | −4.3299E−03 | 2.9643E−02 | −4.9410E−02 | 6.3205E−02 | −5.2805E−02 |
| R4 | −1.4472E+01 | 9.2329E−03 | 1.0056E−02 | −2.7612E−02 | 4.9208E−02 | −5.0482E−02 |
| R5 | −6.5246E+02 | 5.4989E−03 | −3.5061E−02 | 5.9158E−02 | −7.8511E−02 | 7.8172E−02 |
| R6 | 1.8657E+00 | −7.9123E−03 | −3.1129E−03 | 1.5201E−02 | −2.7415E−02 | 3.3509E−02 |
| R7 | −7.4330E+01 | −2.8307E−02 | −8.7833E−03 | −4.7217E−03 | 1.0614E−02 | −7.0263E−03 |
| R8 | −1.1318E+00 | −3.9465E−03 | −2.4057E−02 | 1.4342E−02 | −7.6962E−03 | 2.5898E−03 |
| R9 | −1.2060E+02 | −3.9424E−03 | −1.4182E−02 | 6.0240E−03 | −1.2180E−03 | −2.3898E−04 |
| R10 | −9.9157E−01 | −7.2926E−02 | 2.2451E−02 | −6.2346E−03 | 9.6868E−04 | −3.7608E−05 |
| R11 | −8.3190E+00 | 1.5255E−02 | −2.4427E−02 | 1.2865E−02 | −5.0878E−03 | 1.3527E−03 |
| R12 | −8.2534E−01 | 3.2121E−02 | −2.2456E−02 | 7.3718E−03 | −1.9787E−03 | 4.0339E−04 |
| R13 | 9.5346E−01 | −5.7866E−02 | 1.1569E−02 | −1.1985E−03 | 1.7453E−04 | −2.6577E−05 |
| R14 | −7.0629E+00 | −2.8960E−02 | 6.5932E−03 | −1.2542E−03 | 1.8769E−04 | −1.9910E−05 |
| | | Conic | | | | |
| | | coefficient | Aspherical surface coefficient | | | |
| | | k | A14 | A16 | A18 | A20 |
| | R1 | −2.7433E−01 | 8.8022E−04 | −1.7923E−04 | 1.5085E−05 | −1.8061E−07 |
| | R2 | −7.1437E+01 | 7.5583E−03 | −1.8713E−03 | 2.5035E−04 | −1.3912E−05 |
| | R3 | −1.4587E+01 | 2.7396E−02 | −8.4970E−03 | 1.4547E−03 | −1.0595E−04 |
| | R4 | −1.4472E+01 | 3.0085E−02 | −9.9735E−03 | 1.6183E−03 | −6.2680E−05 |
| | R5 | −6.5246E+02 | −5.2538E−02 | 2.2366E−02 | −5.3214E−03 | 5.4042E−04 |
| | R6 | 1.8657E+00 | −2.1841E−02 | 7.3017E−03 | −8.2261E−04 | −6.7055E−05 |
| | R7 | −7.4330E+01 | 2.4282E−03 | −8.0144E−04 | 3.4647E−04 | −6.2367E−05 |
| | R8 | −1.1318E+00 | −2.4492E−04 | −1.5250E−04 | 4.9469E−05 | −3.2501E−06 |
| | R9 | −1.2060E+02 | 1.3428E−04 | −6.9829E−06 | −3.9722E−06 | 4.9892E−07 |
| | R10 | −9.9157E−01 | −5.3273E−06 | −1.9473E−07 | 1.3324E−07 | −7.8765E−09 |
| | R11 | −8.3190E+00 | −2.2737E−04 | 2.2887E−05 | −1.2525E−06 | 2.8636E−08 |
| | R12 | −8.2534E−01 | −5.5704E−05 | 4.7259E−06 | −2.1899E−07 | 4.2222E−09 |
| | R13 | 9.5346E−01 | 2.4976E−06 | −1.3183E−07 | 3.6478E−09 | −4.1283E−11 |
| | R14 | −7.0629E+00 | 1.3624E−06 | −5.5425E−08 | 1.1971E−09 | −1.0375E−11 |

Here, k denotes a conic coefficient, and A4, A6, A8, A10, Al2, A14, A16, A18, and A20 denote an aspherical coefficient, respectively.

y=(x²/R)/{1+[1−(k+1)(x²/R²)]^{1/2}}+A4x⁴+A6x⁶+A8x⁸+A10x¹⁰+A12x¹²+A14x¹⁴+A16x¹⁶+A18x¹⁸+A20x²⁰ (4).

Here, x denotes a vertical distance between a point on an aspherical curve and the optical axis, and y denotes a depth of the aspherical surface, i.e., a vertical distance between a point on the aspherical surface having a distance x from the optical axis and a tangent plane tangent to a vertex on an aspherical optical axis.

For convenience, the aspherical surface of each lens surface uses the aspherical surface shown in the above formula (4). However, the present invention is not limited to the aspherical polynomial form shown in the formula (4).

Design data of the inflection point and the arrest point of each lens in the camera optical lens 10 according to Embodiment 1 of the present invention are shown in Tables 3 and 4. Here, P1R1 and P1R2 denote the object side surface and image side surface of the first lens L1, respectively. P2R1 and P2R2 denote the object side surface and image side surface of the second lens L2, respectively. P3R1 and P3R2 denote the object side surface and image side surface of the third lens L3, respectively. P4R1 and P4R2 denote the object side surface and image side surface of the fourth lens L4, respectively. P5R1 and P5R2 denote the object side surface and image side surface of the fifth lens L5, respectively. P6R1 and P6R2 denote the object side surface and image side surface of the sixth lens L6, respectively. P7R1 and P7R2 denote the object side surface and image side surface of the seventh lens L7, respectively. Data in an “inflection point position” column are a vertical distance from an inflexion point provided on a surface of each lens to the optical axis of the camera optical lens 10. Data in an “arrest point position” column are a vertical distance from an arrest point provided on the surface of each lens to the optical axis of the camera optical lens 10.

TABLE 3

| | Number of | Inflexion point | Inflexion point | Inflexion point | Inflexion point |
|---|---|---|---|---|---|
| | inflexion points | position 1 | position 2 | position 3 | position 4 |
| P1R1 | 1 | 1.535 | / | / | / |
| P1R2 | 1 | 1.045 | / | / | / |
| P2R1 | 0 | / | / | / | / |
| P2R2 | 0 | / | / | / | / |
| P3R1 | 0 | / | / | / | / |
| P3R2 | 0 | / | / | / | / |
| P4R1 | 1 | 1.375 | / | / | / |
| P4R2 | 1 | 1.645 | / | / | / |
| P5R1 | 2 | 0.675 | 2.165 | / | / |
| P5R2 | 1 | 0.645 | / | / | / |
| P6R1 | 2 | 0.965 | 2.745 | / | / |
| P6R2 | 3 | 0.365 | 0.995 | 2.905 | / |
| P7R1 | 2 | 1.955 | 4.075 | / | / |
| P7R2 | 4 | 0.635 | 3.445 | 4.015 | 4.325 |

TABLE 4

| | Number of | Arrest point | Arrest point |
|---|---|---|---|
| | arrest points | position 1 | position 2 |
| P1R1 | 0 | / | / |
| P1R2 | 1 | 1.425 | / |
| P2R1 | 0 | / | / |
| P2R2 | 0 | / | / |
| P3R1 | 0 | / | / |
| P3R2 | 0 | / | / |
| P4R1 | 0 | / | / |
| P4R2 | 0 | / | / |
| P5R1 | 1 | 1.175 | / |
| P5R2 | 1 | 1.245 | / |
| P6R1 | 1 | 1.625 | / |
| P6R2 | 2 | 0.715 | 1.205 |
| P7R1 | 1 | 3.415 | / |
| P7R2 | 1 | 1.275 | / |

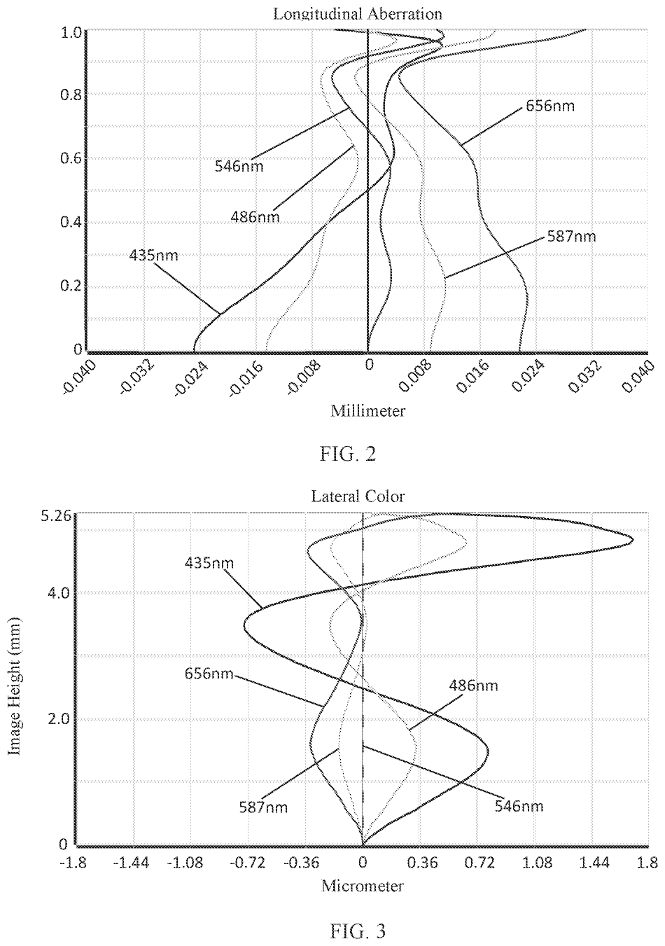

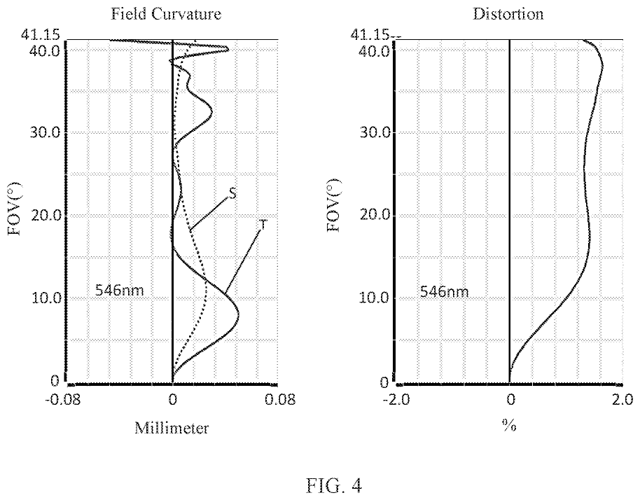

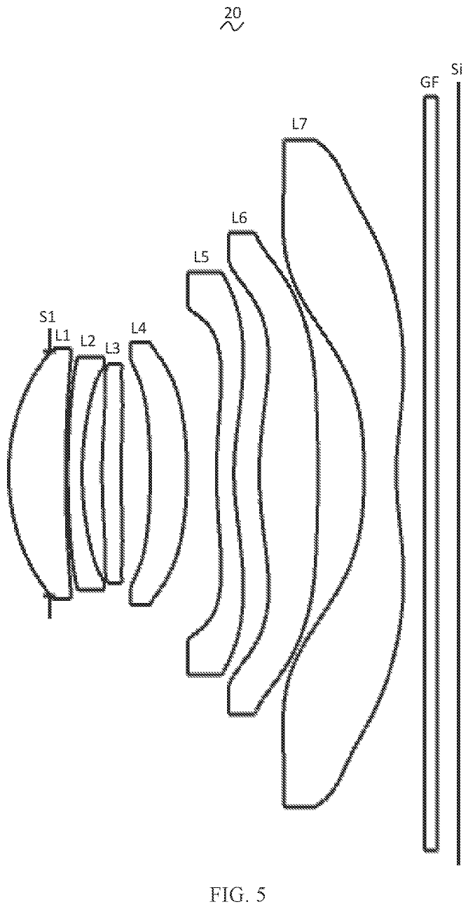

FIG. 2 and FIG. 3 are schematic diagrams of a longitudinal aberration and a lateral color of the camera optical lens 10 after light having a wavelength of 435 nm, 486 nm, 546 nm, 587 nm and 656 nm passes through the camera optical lens 10 according to Embodiment 1, respectively. FIG. 4 is a schematic diagram of a field curvature and a distortion of the camera optical lens 10 after light having a wavelength of 546 nm passes through the camera optical lens 10 according to Embodiment 1. A field curvature S in FIG. 4 is a field curvature in a sagittal direction, and T is a field curvature in a meridian direction.

In addition, Table 13 below shows numerical values according to Embodiment 1 corresponding to parameters specified in the conditions.

As shown in Table 13, Embodiment 1 satisfies various conditions. In this embodiment, an entrance pupil diameter ENPD of the camera optical lens 10 is 3.369 mm, a full-field image height IH is 5.264 mm, and a field of view FOV in a diagonal direction is 82.30°. The satisfy design requirements for large aperture, wide angle and ultra-thinness. Its on-axis and off-axis chromatic aberrations are fully corrected, thereby achieving excellent optical performances.

### Embodiment 2

Embodiment 2 is basically the same as Embodiment 1, and involves symbols having the same meanings as Embodiment 1 which are not elaborated here.

Table 5 shows design data of the camera optical lens 20 according to Embodiment 2 of the present invention.

TABLE 5

| | R | d | | nd | | vd | |
|---|---|---|---|---|---|---|---|
| S1 | ∞ | d0 = | −0.636 | | | | |
| R1 | 3.358 | d1 = | 0.891 | nd1 | 1.5444 | v1 | 55.82 |
| R2 | 10.585 | d2 = | 0.035 | | | | |
| R3 | 4.463 | d3 = | 0.224 | nd2 | 1.6700 | v2 | 19.39 |
| R4 | 4.545 | d4 = | 0.309 | | | | |
| R5 | 11.142 | d5 = | 0.300 | nd3 | 1.6153 | v3 | 25.94 |
| R6 | −4.639 | d6 = | 0.454 | | | | |
| R7 | −4.596 | d7 = | 0.579 | nd4 | 1.5444 | v4 | 55.82 |
| R8 | 1.383 | d8 = | 0.460 | | | | |
| R9 | 4.059 | d9 = | 0.274 | nd5 | 1.5876 | v5 | 29.04 |
| R10 | −1.116 | d10 = | 0.396 | | | | |
| R11 | 3.370 | d11 = | 0.919 | nd6 | 1.5346 | v6 | 55.69 |
| R12 | 1.754 | d12 = | 0.720 | | | | |
| R13 | −6.534 | d13 = | 0.504 | nd7 | 1.5444 | v7 | 55.82 |
| R14 | 2.258 | d14 = | 0.436 | | | | |
| R15 | ∞ | d15 = | 0.210 | ndg | 1.5168 | vg | 64.17 |
| R16 | ∞ | d16 = | 0.330 | | | | |

Table 6 shows aspherical surface data of each lens in the camera optical lens 20 according to Embodiment 2 of the present invention.

TABLE 6

| | Conic | | | | | |
|---|---|---|---|---|---|---|
| | coefficient | Aspherical surface coefficient | | | | |
| | k | A4 | A6 | A8 | A10 | A12 |
| R1 | −9.0500E−02 | 5.6742E−03 | 4.1952E−03 | −5.3082E−03 | 4.9543E−03 | −2.6560E−03 |
| R2 | −2.5373E−01 | −1.8956E−03 | 1.7353E−02 | −2.7301E−02 | 2.7259E−02 | −1.8073E−02 |
| R3 | −1.1067E+01 | −2.2451E−03 | 2.9984E−02 | −4.9867E−02 | 6.3082E−02 | −5.2699E−02 |
| R4 | −2.2029E+01 | 1.1491E−02 | 9.1637E−03 | −2.5769E−02 | 4.9238E−02 | −5.0742E−02 |
| R5 | −2.4730E+02 | −5.4629E−03 | −4.0932E−02 | 5.9321E−02 | −7.8126E−02 | 7.8158E−02 |
| R6 | 5.5606E+00 | −1.5391E−02 | −1.0292E−02 | 1.4569E−02 | −2.7550E−02 | 3.3949E−02 |
| R7 | −1.8398E+01 | −2.8739E−02 | −8.5136E−03 | −7.3580E−03 | 1.1080E−02 | −6.7856E−03 |
| R8 | −9.7342E−01 | 3.1151E−03 | −2.5735E−02 | 1.3860E−02 | −7.5462E−03 | 2.6750E−03 |
| R9 | −2.9682E+01 | 2.2896E−03 | −1.1535E−02 | 5.3404E−03 | −1.1666E−03 | −2.2222E−04 |
| R10 | −9.6286E−01 | −7.3544E−02 | 2.5281E−02 | −6.5714E−03 | 9.3897E−04 | −3.2494E−05 |
| R11 | −6.3273E+00 | 8.1521E−03 | −2.2162E−02 | 1.2764E−02 | −5.1072E−03 | 1.3528E−03 |
| R12 | −8.3941E−01 | 2.5055E−02 | −2.0702E−02 | 7.2790E−03 | −1.9813E−03 | 4.0371E−04 |
| R13 | 7.0062E−01 | −5.9888E−02 | 1.1674E−02 | −1.2020E−03 | 1.7447E−04 | −2.6577E−05 |
| R14 | −5.8163E+00 | −2.7994E−02 | 6.8104E−03 | −1.2692E−03 | 1.8735E−04 | −1.9918E−05 |
| | | Conic | | | | |
| | | coefficient | Aspherical surface coefficient | | | |
| | | k | A14 | A16 | A18 | A20 |
| | R1 | −9.0500E−02 | 8.6917E−04 | −1.7332E−04 | 2.0964E−05 | −1.5546E−06 |
| | R2 | −2.5373E−01 | 7.5591E−03 | −1.8816E−03 | 2.4766E−04 | −1.2661E−05 |
| | R3 | −1.1067E+01 | 2.7424E−02 | −8.5125E−03 | 1.4431E−03 | −1.0273E−04 |
| | R4 | −2.2029E+01 | 2.9943E−02 | −9.9177E−03 | 1.6794E−03 | −8.8187E−05 |
| | R5 | −2.4730E+02 | −5.2673E−02 | 2.2395E−02 | −5.2307E−03 | 5.1038E−04 |
| | R6 | 5.5606E+00 | −2.1814E−02 | 7.2240E−03 | −8.7000E−04 | −3.4147E−05 |
| | R7 | −1.8398E+01 | 2.3976E−03 | −8.0329E−04 | 3.4841E−04 | −6.6628E−05 |
| | R8 | −9.7342E−01 | −2.5292E−04 | −1.5841E−04 | 5.2153E−05 | −3.9793E−06 |
| | R9 | −2.9682E+01 | 1.3404E−04 | −8.0272E−06 | −4.0783E−06 | 5.2958E−07 |
| | R10 | −9.6286E−01 | −5.8396E−06 | −1.9162E−07 | 1.5475E−07 | −9.5152E−09 |
| | R11 | −6.3273E+00 | −2.2742E−04 | 2.2919E−05 | −1.2439E−06 | 2.7651E−08 |
| | R12 | −8.3941E−01 | −5.5667E−05 | 4.7239E−06 | −2.1948E−07 | 4.2543E−09 |
| | R13 | 7.0062E−01 | 2.4977E−06 | −1.3183E−07 | 3.6468E−09 | −4.1301E−11 |
| | R14 | −5.8163E+00 | 1.3640E−06 | −5.5342E−08 | 1.1965E−09 | −1.0563E−11 |

Design data of the inflection point and the arrest point of each lens in the camera optical lens 20 according to Embodiment 2 of the present invention are shown in Tables 7 and 8.

TABLE 7

| | Number of | Inflexion point | Inflexion point | Inflexion point |
|---|---|---|---|---|
| | inflexion points | position 1 | position 2 | position 3 |
| P1R1 | 0 | / | / | / |
| P1R2 | 1 | 1.355 | / | / |
| P2R1 | 0 | / | / | / |
| P2R2 | 0 | / | / | / |
| P3R1 | 2 | 0.625 | 1.175 | / |
| P3R2 | 2 | 0.545 | 1.205 | / |
| P4R1 | 2 | 1.435 | 1.525 | / |
| P4R2 | 1 | 1.645 | / | / |
| P5R1 | 2 | 0.715 | 2.195 | / |
| P5R2 | 1 | 0.735 | / | / |
| P6R1 | 3 | 0.905 | 2.575 | 2.925 |
| P6R2 | 1 | 2.885 | / | / |
| P7R1 | 2 | 1.955 | 3.645 | / |
| P7R2 | 3 | 0.685 | 3.525 | 3.995 |

TABLE 8

| | Number of arrest | Arrest point | Arrest point |
|---|---|---|---|
| | points | position 1 | position 2 |
| P1R1 | 0 | / | / |
| P1R2 | 0 | / | / |
| P2R1 | 0 | / | / |
| P2R2 | 0 | / | / |
| P3R1 | 2 | 1.145 | 1.205 |
| P3R2 | 2 | 0.905 | 1.345 |
| P4R1 | 0 | / | / |
| P4R2 | 0 | / | / |
| P5R1 | 1 | 1.295 | / |
| P5R2 | 1 | 1.555 | / |
| P6R1 | 1 | 1.545 | / |
| P6R2 | 0 | / | / |
| P7R1 | 2 | 3.415 | 3.845 |
| P7R2 | 1 | 1.425 | / |

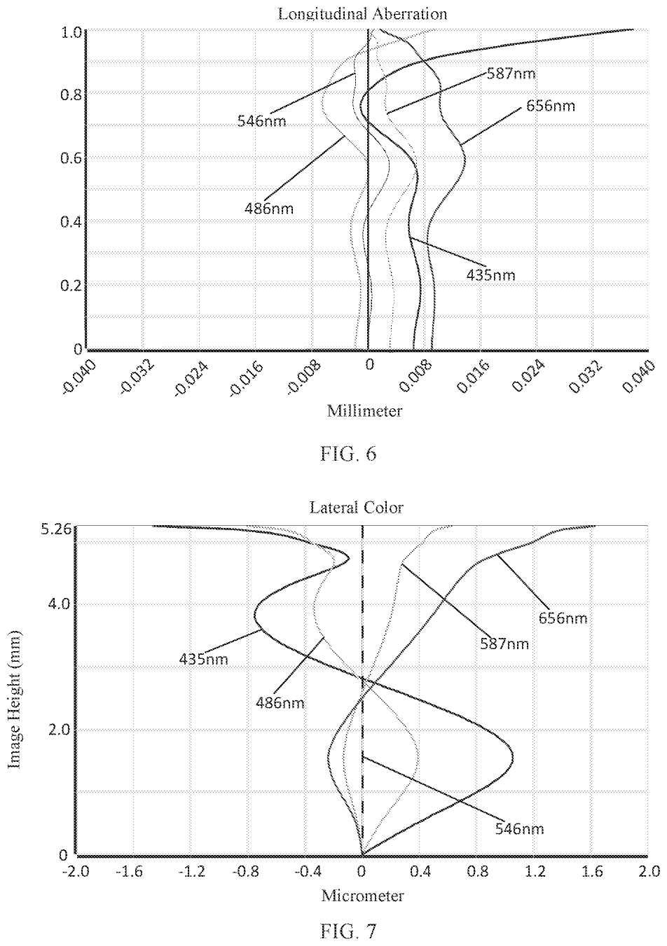

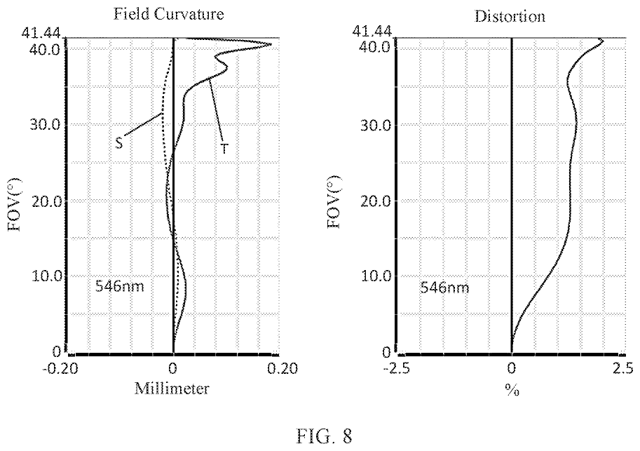

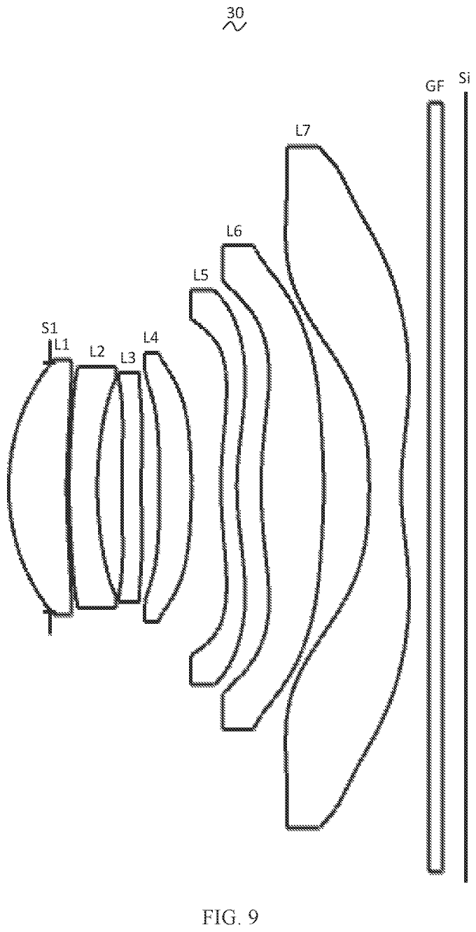

FIG. 6 and FIG. 7 are schematic diagrams of a longitudinal aberration and a lateral color of the camera optical lens 20 after light having a wavelength of 435 nm, 486 nm, 546 nm, 587 nm and 656 nm passes through the camera optical lens 20 according to Embodiment 2, respectively. FIG. 8 is a schematic diagram of a field curvature and a distortion after light having a wavelength of 546 nm passes through the camera optical lens 20 according to Embodiment 2 of the present invention.

In addition, Table 13 below shows numerical values according to Embodiment 2 corresponding to parameters specified in the conditions.

As shown in Table 13, Embodiment 2 satisfies various conditions.

In this embodiment, an entrance pupil diameter ENPD of the camera optical lens 20 is 3.315 mm, a full-field image height IH is 5.264 mm, and a field of view FOV in a diagonal direction is 82.88°. The camera optical lens 20 satisfies design requirements for large aperture, wide angle, and ultra-thinness. Its on-axis and off-axis chromatic aberrations are fully corrected, thereby achieving excellent optical performances.

### Embodiment 3

Embodiment 3 is basically the same as Embodiment 1, and involves symbols having the same meanings as Embodiment 1 which are not elaborated here.

Tables 9 shows design data of the camera optical lens 30 of Embodiment 3 of the present invention.

TABLE 9

| | R | d | | nd | | vd | |
|---|---|---|---|---|---|---|---|
| S1 | ∞ | d0 = | −0.636 | | | | |
| R1 | 3.248 | d1 = | 0.897 | nd1 | 1.5444 | v1 | 55.82 |
| R2 | 5.062 | d2 = | 0.037 | | | | |
| R3 | 3.675 | d3 = | 0.441 | nd2 | 1.6700 | v2 | 19.39 |
| R4 | 4.945 | d4 = | 0.378 | | | | |
| R5 | 11.162 | d5 = | 0.300 | nd3 | 1.6153 | v3 | 25.94 |
| R6 | −4.517 | d6 = | 0.277 | | | | |
| R7 | −25.448 | d7 = | 0.498 | nd4 | 1.5444 | v4 | 55.82 |
| R8 | 1.178 | d8 = | 0.455 | | | | |
| R9 | 4.556 | d9 = | 0.247 | nd5 | 1.5876 | v5 | 29.04 |
| R10 | −1.090 | d10 = | 0.378 | | | | |
| R11 | 3.568 | d11 = | 0.968 | nd6 | 1.5346 | v6 | 55.69 |
| R12 | 1.810 | d12 = | 0.702 | | | | |
| R13 | −6.221 | d13 = | 0.494 | nd7 | 1.5444 | v7 | 55.82 |
| R14 | 2.089 | d14 = | 0.436 | | | | |
| R15 | ∞ | d15 = | 0.210 | ndg | 1.5168 | vg | 64.17 |
| R16 | ∞ | d16 = | 0.356 | | | | |

Table 10 shows aspherical surface data of each lens in the camera optical lens 30 of Embodiment 3 of the present invention.

TABLE 10

| | Conic | | | | | |
|---|---|---|---|---|---|---|
| | coefficient | Aspherical surface coefficient | | | | |
| | k | A4 | A6 | A8 | A10 | A12 |
| R1 | −2.3206E−01 | 5.0271E−03 | 5.0614E−03 | −5.7780E−03 | 4.9248E−03 | −2.6131E−03 |
| R2 | −6.3479E+01 | −6.4648E−03 | 1.9092E−02 | −2.7088E−02 | 2.7181E−02 | −1.8124E−02 |
| R3 | −1.9166E+01 | −5.5730E−03 | 2.9472E−02 | −4.9405E−02 | 6.3181E−02 | −5.2813E−02 |
| R4 | −1.1392E+01 | 1.3308E−02 | 8.0708E−03 | −2.6564E−02 | 4.9290E−02 | −5.0530E−02 |
| R5 | −1.0276E+02 | −2.4100E−03 | −3.7064E−02 | 5.9403E−02 | −7.9290E−02 | 7.7854E−02 |
| R6 | 5.1283E+00 | −1.6482E−02 | −6.3506E−03 | 1.4887E−02 | −2.7455E−02 | 3.3414E−02 |
| R7 | −9.0527E+01 | −2.7006E−02 | −7.5964E−03 | −5.9491E−03 | 1.0706E−02 | −6.9434E−03 |
| R8 | −1.1209E+00 | −3.3443E−03 | −2.3717E−02 | 1.4618E−02 | −7.6929E−03 | 2.5922E−03 |
| R9 | −5.4410E+01 | −3.1845E−03 | −1.2939E−02 | 5.9831E−03 | −1.2328E−03 | −2.3883E−04 |
| R10 | −9.8847E−01 | −7.1120E−02 | 2.2374E−02 | −6.3011E−03 | 9.6436E−04 | −3.7640E−05 |
| R11 | −6.2596E+00 | 1.3802E−02 | −2.3253E−02 | 1.2727E−02 | −5.0904E−03 | 1.3532E−03 |
| R12 | −8.2082E−01 | 3.2110E−02 | −2.1741E−02 | 7.3525E−03 | −1.9798E−03 | 4.0335E−04 |
| R13 | 1.0446E+00 | −5.8737E−02 | 1.1651E−02 | −1.2005E−03 | 1.7453E−04 | −2.6579E−05 |
| R14 | −6.0618E+00 | −2.6354E−02 | 6.6192E−03 | −1.2662E−03 | 1.8767E−04 | −1.9903E−05 |
| | | Conic | | | | |
| | | coefficient | Aspherical surface coefficient | | | |
| | | k | A14 | A16 | A18 | A20 |
| | R1 | −2.3206E−01 | 8.8719E−04 | −1.7713E−04 | 1.5369E−05 | −2.2358E−07 |
| | R2 | −6.3479E+01 | 7.5583E−03 | −1.8742E−03 | 2.4944E−04 | −1.3434E−05 |
| | R3 | −1.9166E+01 | 2.7393E−02 | −8.4968E−03 | 1.4552E−03 | −1.0636E−04 |
| | R4 | −1.1392E+01 | 3.0038E−02 | −1.0010E−02 | 1.6059E−03 | −6.3104E−05 |
| | R5 | −1.0276E+02 | −5.2592E−02 | 2.2372E−02 | −5.3045E−03 | 5.3706E−04 |
| | R6 | 5.1283E+00 | −2.1956E−02 | 7.2239E−03 | −8.2916E−04 | −3.3693E−05 |
| | R7 | −9.0527E+01 | 2.4674E−03 | −7.9952E−04 | 3.4641E−04 | −6.4388E−05 |
| | R8 | −1.1209E+00 | −2.4365E−04 | −1.5296E−04 | 4.9600E−05 | −3.2979E−06 |
| | R9 | −5.4410E+01 | 1.3427E−04 | −7.0495E−06 | −3.9875E−06 | 4.9770E−07 |
| | R10 | −9.8847E−01 | −5.2358E−06 | −1.9166E−07 | 1.3413E−07 | −7.9483E−09 |
| | R11 | −6.2596E+00 | −2.2735E−04 | 2.2887E−05 | −1.2522E−06 | 2.8710E−08 |
| | R12 | −8.2082E−01 | −5.5703E−05 | 4.7261E−06 | −2.1899E−07 | 4.2220E−09 |
| | R13 | 1.0446E+00 | 2.4974E−06 | −1.3184E−07 | 3.6479E−09 | −4.1251E−11 |
| | R14 | −6.0618E+00 | 1.3630E−06 | −5.5404E−08 | 1.1971E−09 | −1.0465E−11 |

Design data of the inflection point and the arrest point of each lens in the camera optical lens 30 according to Embodiment 3 of the present invention are shown in Tables 11 and 12.

TABLE 11

| | Number of | Inflexion | Inflexion | Inflexion | Inflexion |
|---|---|---|---|---|---|
| | inflexion | point | point | point | point |
| | points | position 1 | position 2 | position 3 | position 4 |
| P1R1 | 1 | 1.675 | / | / | / |
| P1R2 | 1 | 1.115 | / | / | / |
| P2R1 | 0 | / | / | / | / |
| P2R2 | 0 | / | / | / | / |
| P3R1 | 2 | 0.485 | 1.385 | / | / |
| P3R2 | 3 | 0.435 | 1.255 | 1.515 | / |
| P4R1 | 2 | 1.365 | 1.615 | / | / |
| P4R2 | 1 | 1.625 | / | / | / |
| P5R1 | 2 | 0.725 | 2.195 | / | / |
| P5R2 | 1 | 0.725 | / | / | / |
| P6R1 | 2 | 0.905 | 2.635 | / | / |
| P6R2 | 1 | 2.885 | / | / | / |
| P7R1 | 3 | 1.955 | 3.705 | 3.975 | / |
| P7R2 | 4 | 0.675 | 3.515 | 3.985 | 4.515 |

TABLE 12

| | Number of | Arrest point | Arrest point |
|---|---|---|---|
| | arrest points | position 1 | position 2 |
| P1R1 | 0 | / | / |
| P1R2 | 0 | / | / |
| P2R1 | 0 | / | / |
| P2R2 | 0 | / | / |
| P3R1 | 1 | 0.805 | / |
| P3R2 | 2 | 0.725 | 1.425 |
| P4R1 | 0 | / | / |
| P4R2 | 0 | / | / |
| P5R1 | 1 | 1.305 | / |
| P5R2 | 1 | 1.425 | / |
| P6R1 | 1 | 1.505 | / |
| P6R2 | 0 | / | / |
| P7R1 | 1 | 3.395 | / |
| P7R2 | 1 | 1.435 | / |

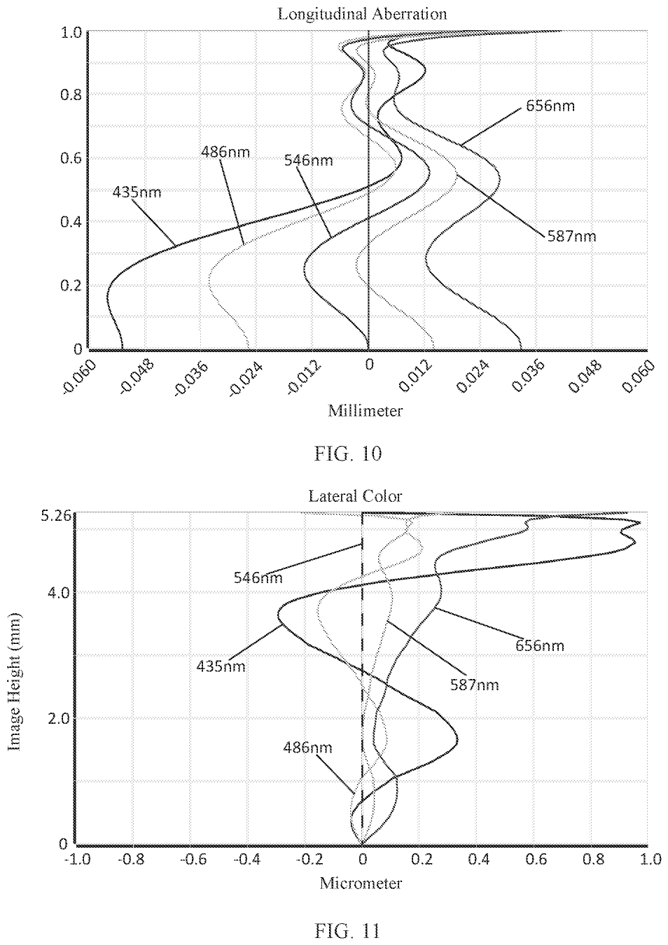

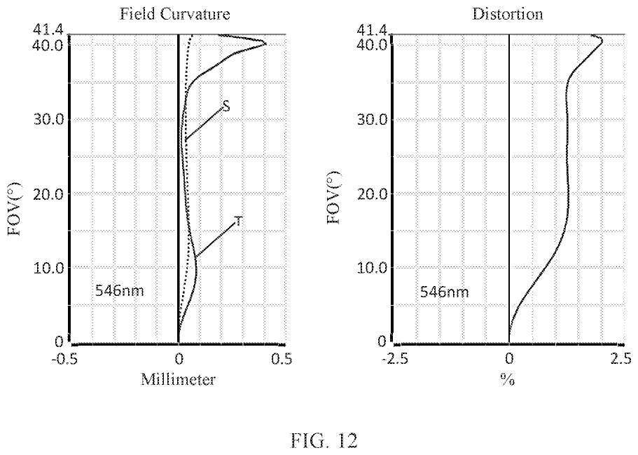

FIG. 10 and FIG. 11 are schematic diagrams of a longitudinal aberration and a lateral color after light having a wavelength of 435 nm, 486 nm, 546 nm, 587 nm, and 656 nm passes through the camera optical lens 30 according to Embodiment 3. FIG. 12 is a schematic diagram of a field curvature and a distortion of the camera optical lens 30 after light having a wavelength of 546 nm passes through the camera optical lens 30 according to Embodiment 3.

In addition, Table 13 below shows numerical values according to Embodiment 3 corresponding to parameters specified in the conditions.

As shown in Table 13, Embodiment 3 satisfies various conditions

In this embodiment, an entrance pupil diameter ENPD of the camera optical lens 30 is 3.326 mm, a full-field image height IH is 5.264 mm, and a field of view FOV in a diagonal direction is 82.80°. The camera optical lens 30 satisfies design requirements for large aperture, wide angle and ultra-thinness. Its on-axis and off-axis chromatic aberrations are fully corrected, thereby achieving excellent optical performances.

Table 13 below shows numerical values corresponding to parameters specified in the conditions in Embodiments 1, 2 and 3, and values of other related parameters.

TABLE 13

| Parameters and | | | |
|---|---|---|---|
| conditions | Embodiment 1 | Embodiment 2 | Embodiment 3 |
| f | 5.946 | 5.850 | 5.870 |
| f1 | 5.433 | 5.072 | 6.426 |
| f2 | −12.058 | −8.960 | −23.359 |
| f3 | 46.797 | 25.570 | 751.862 |
| f4 | 44.311 | 16.793 | 22.058 |
| f5 | −23.120 | −13.419 | −26.625 |
| f6 | 5.920 | 5.979 | 5.613 |
| f7 | −4.194 | −4.016 | −3.653 |
| f12 | 8.379 | 9.461 | 8.014 |
| FNO | 1.77 | 1.77 | 1.77 |
| TTL | 6.996 | 7.041 | 7.074 |
| IH | 5.264 | 5.264 | 5.264 |
| FOV | 82.30° | 82.88° | 82.80° |
| f2/f | −2.03 | −1.53 | −3.98 |
| f5/f7 | 5.51 | 3.34 | 7.29 |
| R7/R8 | −7.57 | −3.32 | −21.60 |

The above are only preferred embodiments of the present disclosure. Here, it should be noted that those skilled in the art may make modifications without departing from the inventive concept of the present disclosure, but these shall fall into the protection scope of the present disclosure.

What is claimed is:

1. A camera optical lens, comprising from an object side to an image side:
a first lens having positive refractive power;
a second lens having negative refractive power;
a third lens having positive refractive power;
a fourth lens having positive refractive power;
a fifth lens having negative refractive power;
a sixth lens having positive refractive power; and
a seventh lens having negative refractive power,
wherein the camera optical lens satisfies following conditions:
−4.00≤f2/f≤−1.50;
3.20≤f5/f7≤7.50; and
R7/R8≤−3.20,
where
f denotes a total focal length of the camera optical lens;
f2 denotes a focal length of the second lens;
f5 denotes a focal length of the fifth lens;
f7 denotes a focal length of the seventh lens;
R7 denotes a curvature radius of an object side surface of the fourth lens; and
R8 denotes a curvature radius of an image side surface of the fourth lens.

2. The camera optical lens as described in claim 1, wherein the camera optical lens further satisfies a following condition:
2.00≤d1/d3≤4.00,
where
d1 denotes an on-axis thickness of the first lens; and
d3 denotes an on-axis thickness of the second lens.

3. The camera optical lens as described in claim 1, wherein the camera optical lens further satisfies following conditions:
0.43≤f1/f≤1.64;
−9.16≤(R1+R2)/(R1−R2)≤−1.29; and
0.06≤d1/TTL≤0.19,
where
f1 denotes a focal length of the first lens;
R1 denotes a central curvature radius of an object side surface of the first lens;
R2 denotes a central curvature radius of an image side surface of the first lens;
d1 denotes an on-axis thickness of the first lens; and
TTL denotes a total optical length from the object side surface of the first lens to an image plane of the camera optical lens along an optic axis.

4. The camera optical lens as described in claim 1, wherein the camera optical lens further satisfies following conditions:
−219.71≤(R3+R4)/(R3−R4)≤−4.52; and
0.02≤d3/TTL≤0.09,
where
R3 denotes a curvature radius of an object side surface of the second lens;
R4 denotes a curvature radius of an image side surface of the second lens;
d3 denotes an on-axis thickness of the second lens; and
TTL denotes a total optical length from an object side surface of the first lens to an image plane of the camera optical lens along an optic axis.

5. The camera optical lens as described in claim 1, wherein the camera optical lens further satisfies following conditions:
2.19≤f3/f≤192.13;
0.21≤(R5+R6)/(R5−R6)≤0.83; and
0.02≤d5/TTL≤0.06,
where
f3 denotes a focal length of the third lens;
R5 denotes a curvature radius of an object side surface of the third lens;
R6 denotes a curvature radius of an image side surface of the third lens;
d5 denotes an on-axis thickness of the third lens; and
TTL denotes a total optical length from an object side surface of the first lens to an image plane of the camera optical lens along an optic axis.

6. The camera optical lens as described in claim 1, wherein the camera optical lens further satisfies following conditions:
1.44≤f4/f≤11.18;
0.27≤(R7+R8)/(R7−R8)≤1.37; and
0.04≤d7/TTL≤0.12,
where
f4 denotes a focal length of the fourth lens;
d7 denotes an on-axis thickness of the fourth lens; and
TTL denotes a total optical length from an object side surface of the first lens to an image plane of the camera optical lens along an optic axis.

7. The camera optical lens as described in claim 1, wherein the camera optical lens further satisfies following conditions:
−9.07≤f5/f≤−1.53;
0.28≤(R9+R10)/(R9−R10)≤1.08; and
0.02≤d9/TTL≤0.08,
R9 denotes a curvature radius of an object side surface of the fifth lens;
R10 denotes a curvature radius of an image side surface of the fifth lens;
d9 denotes an on-axis thickness of the fifth lens; and
TTL denotes a total optical length from an object side surface of the first lens to an image plane of the camera optical lens along an optic axis.

8. The camera optical lens as described in claim 1, wherein the camera optical lens further satisfies following conditions:
0.48≤f6/f≤1.53;
1.53≤(R11+R12)/(R11−R12)≤4.76; and
0.05≤d11/TTL≤0.21,
where
f6 denotes a focal length of the sixth lens;
R11 denotes a curvature radius of an object side surface of the sixth lens;
R12 denotes a curvature radius of an image side surface of the sixth lens;
d11 denotes an on-axis thickness of the sixth lens; and
TTL denotes a total optical length from an object side surface of the first lens to an image plane of the camera optical lens along an optic axis.

9. The camera optical lens as described in claim 1, wherein the camera optical lens further satisfies following conditions:
−1.41≤f7/f≤−0.41;
0.20≤(R13+R14)/(R13−R14)≤0.75; and
0.03≤d13/TTL≤0.11,
R13 denotes a curvature radius of an object side surface of the seventh lens;
R14 denotes a curvature radius of an image side surface of the seventh lens;
d13 denotes an on-axis thickness of the seventh lens; and
TTL denotes a total optical length from an object side surface of the first lens to an image plane of the camera optical lens along an optic axis.

10. The camera optical lens as described in claim 1, wherein the camera optical lens further satisfies a following condition:
FNO≤1.82,
where FNO denotes an F number of the camera optical lens.
